(19) United States
(12) Patent Application Publication
(10) Pub. No.: US 2008/0172257 A1
(43) Pub. Date: Jul. 17, 2008

(54) Health Insurance Fraud Detection Using Social Network Analytics

(76) Inventors: James H. Bisker, Ostrander, OH (US); Brenda L. Dietrich, Yorktown Heights, NY (US); Kate Ehrlich, Newton, MA (US); Mary Elizabeth Helander, North White Plains, NY (US); Ching-Yung Lin, Forest Hills, NY (US); Patreece Williams, Briarcliff Manor, NY (US)

Correspondence Address: Whitham, Curtis, & Christofferson, P.C., Suite 340, 11491 Sunset Hills Road, Reston, VA, 20190, US

(21) Appl. No.: 11/622,740

(22) Filed: Jan. 12, 2007

(51) Int. Cl. G06Q 40/00

(52) U.S. Cl. 705/4

(57) ABSTRACT

Healthcare fraud detection is accomplished by mining social relationships and analyzing their patterns based on network data structures. Social networks are constructed which depict referral patterns (from health insurance claim information) and associations (from publicly available connection data) to analyze referral patterns and detect possible fraud, abuse and unnecessary overuse. The fraud and abuse management system supports the various aspects of fraud investigation and management, including prevention, investigation, detection and settlement. Using a unique combination of data mining capabilities and graphical reporting tools, the system can identify potentially fraudulent and abusive behavior before a claim is paid or, retrospectively, analyze providers' past behaviors to flag suspicious patterns.

### BACKGROUND OF THE INVENTION

1. Field of the Invention

The present application generally relates to combating healthcare provider fraud and abuse and, more particularly, to mining social relationships and analyzing their patterns based on network data structures in order to detect fraud, abuse and waste on private health insurers, government-funded health plans and consumers. The invention takes social relationships into account, specifically triangulation of incomplete information and paths beyond direct connections.

2. Background Description

According to estimates from the federal government, and from issues-based groups such as the National Health Care Anti-Fraud Association (NHCAA), as much as ten percent of all healthcare expenditures in the United States may be lost each year to fraud, abuse and waste. That translates to more than US$200 billion—coming largely from healthcare providers attempting to defraud the system. Methods of cheating, such as billing for more expensive services than those actually performed or even conducting medically unnecessary procedures for the purpose of billing insurance, have become more sophisticated and more costly to payers. For example, the NHCAA reported that one Texas chiropractor was caught submitting US$5.7 million in fraudulent claims over a five-year period.

Detecting fraudulent activity is not easy. Given the huge volume of data involved, resource and process limitations have forced many healthcare payers to rely on “pay-and-chase” strategies, in which claims are paid and then later—sometimes years later—investigated for fraud. However, such after-the-fact collections are almost never paid in full. Known solutions to this problem do not take key social network metrics and concepts into account, specifically triangulation of incomplete information and paths beyond direct connections.

### SUMMARY OF THE INVENTION

It is therefore an object of this invention to provide a sophisticated, comprehensive fraud and abuse management solution with both proactive and retrospective detection capabilities that helps healthcare payers identify and pursue fraud cases faster and more cost effectively.

According to the present invention, the problem of healthcare fraud detection is solved by mining social relationships and analyzing their patterns based on network data structures as well as correlation in node attributes and correlation in who is known by whom. More particularly, the invention constructs social networks depicting referral patterns (from health insurance claim information) and associations (from publicly available connection data) to analyze referral patterns and detect possible fraud, abuse and unnecessary overuse.

The fraud and abuse management system according to the invention supports the various aspects of fraud investigation and management, including prevention, investigation, detection and settlement. Using a unique combination of data mining capabilities and graphical reporting tools, the system can identify potentially fraudulent and abusive behavior before a claim is paid or, retrospectively, analyze providers' past behaviors to flag suspicious patterns. In either case, the fraud and abuse management system operates more swiftly and effectively than traditional manual processes—sorting through tens of thousands of providers and tens of millions of claims in minutes, and then ranking providers as to their degree of potentially abusive behavior.

With the ability to drill down into detailed information on each provider or claim, anti-fraud investigators and auditors can zero in on questionable behavior, avoiding dead ends and focusing on the most egregious offenders. A “point-and-click” graphical interface, a reports and database wizard and extensive help documentation make the system relatively easy to learn and simple to use.

Not only does the fraud and abuse management system according to the invention help speed and extend the ability to recover mistakenly paid claims, but the system also promotes compliance by providers and claimants, who quickly realize that fraud detection and enforcement have become more systematic and effective—an outcome known as the “sentinel effect”. Additionally, by automating processes previously conducted manually and by more accurately targeting likely offenders, the system helps enable investigators and auditors to become more productive, handling broader caseloads and conducing a higher proportion of successful investigations. In fact, many healthcare payers realize a significant return on investment within a relative short time after implementation.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 is a diagrammatic illustration of a social network of physicians;

FIG. 2 is a block diagram of a system implementing the concepts of social network computing, analysis and optimization according to the present invention;

FIG. 3 is a flowchart illustrating the logic of the process of constructing a social network and performing social network optimization implemented by the system shown in FIG. 2;

FIG. 4 is a flowchart illustrating the logic of the process of populating a mathematical decision-making model based on the attributes to perform social network analysis implemented by the system of FIG. 2;

FIG. 5 is a flow diagram illustrating the logic of the fraud and abuse management system according to the invention; and

FIG. 6 is a block diagram of an exemplary hardware/information handing system on which the present invention may be practiced.

### DETAILED DESCRIPTION OF A PREFERRED EMBODIMENT OF THE INVENTION

The following definitions are provided for terms used in describing the invention:
Social Network—A social structure where nodes are individuals or organizations and edges or links represent their relationships, communications, influence, and the like.
Social Computing—Refers to the use of social software, such as e-mail, information management, web logs (blogs), wikis¹, auctions, and the like. ¹ “Wiki” is defined in the wiki.org Web site as “a piece of sever software that allows users to freely create and edit Web page content using any Web browser.”
Social Network Analysis (SNA)—A set of methods and metrics that shows how people collaborate, patterns of communication, information-sharing, potential influence and decision-making.

Research in a number of academic fields has demonstrated that social networks operate on many levels, from families up to the level of nations, and play a critical role in determining the way problems are solved, organizations are run, information is shared, and the degree to which individuals succeed in achieving their goals.

Social networking also refers to a category of Internet applications to help connect friends, business partners, or other individuals together using a variety of tools. These applications, known as online social networks are becoming increasingly popular.

Generally, social network theory views social relationships in terms of nodes and ties (or ties). Nodes are the individual actors within the networks, and linkages are the relationships between the actors.

There can be many kinds of linkages between the nodes. In its most simple form, a social network is a map of all of the relevant linkages between the nodes being studied. The network can also be used to determine the social capital of individual actors. These concepts are often displayed in a social network diagram, where nodes are the points and linkages are the lines.

The shape of the social network helps determine a network's usefulness to its individuals. Smaller, tighter networks can be less useful to their members than networks with lots of loose connections (weak ties) to individuals outside the main network. More “open” networks, with many weak ties and social connections, are more likely to introduce new ideas and opportunities to their members than closed networks with many redundant ties. In other words, a group of friends who only do things with each other already share the same knowledge and opportunities. A group of individuals with connections to other social worlds is likely to have access to a wider range of information. It is better for individual success to have connections to a variety of networks rather than many connections within a single network. Similarly, individuals can exercise influence or act as brokers within their social networks by bridging two networks that are not directly linked (called filling social holes).

The power of social network theory stems from its difference from traditional sociological studies, which assume that it is the attributes of individual actors that matter. Social network theory produces an alternate view, where the attributes of individuals are less important than their relationships and ties with other actors within the network. This approach has turned out to be useful for explaining many real-world phenomena, but leaves less room for individual agency, and the ability for individuals to influence their success, since so much of it rests within the structure of their network.

Social networks have also been used to examine how companies interact with each other, characterizing the many informal connections that link executives together, as well as associations and connections between individual employees at different companies. These networks provide ways for companies to gather information, deter competition, and even collude in setting prices or policies.

Power within organizations, for example, generally has been found to come more from the degree to which an individual within a network is at the center of many relationships than actual job title. Social networks also play a key role in hiring, in business success for firms, and in job performance.

Social networking websites (e.g., online social networks) have become widely used in virtual communities. In these communities, an initial set of founders sends out messages inviting members of their own personal networks to join the site. New members repeat the process, growing the total number of members and links in the network. Sites then offer features such as automatic address book updates, viewable profiles, the ability to form new links through “introduction services”, and other forms of online social connections. Social networks can also be organized around business connections.

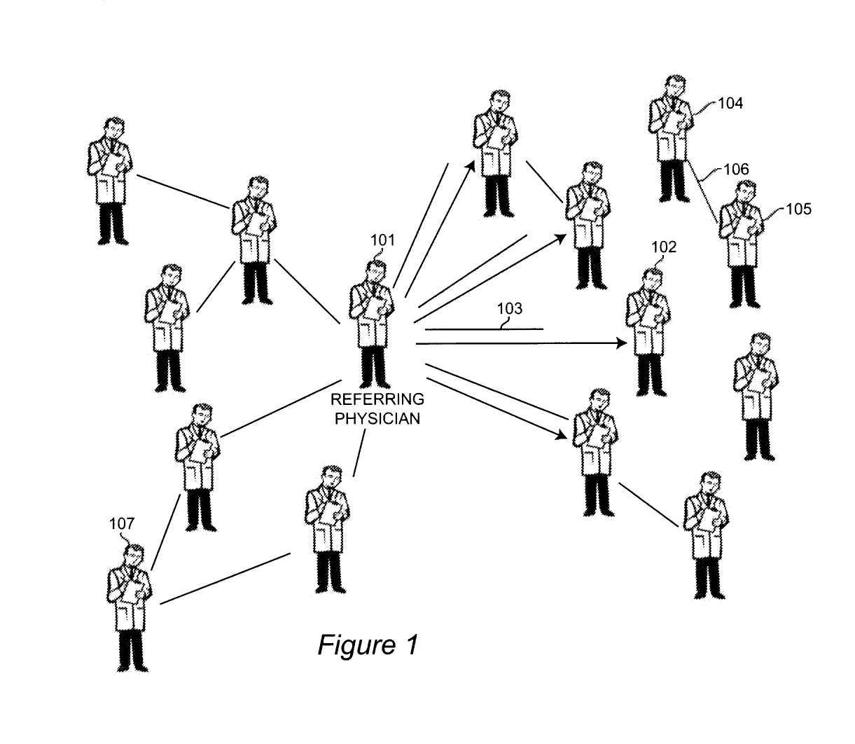

The general concept of using social analytics as applied to health insurance fraud detection can be visualized in the diagram of FIG. 1. Referring to FIG. 1, there is shown a social network of physicians; however, it will be understood for purposes of this invention that the social network typically includes other health care providers as well as physicians. The lines between individual physicians represent “links” which are based on attributes, such as “went to the same university”, “attended same conference”, “co-authored a paper”, etc. that represent the social network In FIG. 1, it will be observed that not all physicians in this exemplary social network are linked to other physicians or other groups of physicians. Roughly in the center of FIG. 1 is a physician 101 labeled as “Referring Physician”. For the purposes of this description, the other physicians represented in FIG. 1 are “Specialists”. Emanating from the “Referring Physician” are several arrowed lines terminating in individual “Specialists”. These represent links based on the referral pattern of the “Referring Physician”.

Considering first “Specialist” physician 102, a link of interest from the “Referring Physician” to this “Specialist” can be detected using the social network mapping, as indicated by the line 103 between the “Referring Physician” and this “Specialist”. As defined above, this link of interest could be having attended the same university or medical school, attended the same conference, co-authored papers, or other such relationship. It will be noted that there is no corresponding link between the “Referring Physician” and “Specialist” physicians 104 and 105; however, a link of interest 106 between physicians 104 and 105 can be detected using the social network mapping. And while there is no corresponding link between the “Referring Physician” and “Specialist” physician 107, two alternate paths from the “Referring Physician” to this “Specialist” physician can be detected using the social network mapping.

FIG. 1 illustrates the use of social network maps to introduce structure to what is otherwise “unstructured” information. Correlation between nodes may be detected among nodes that are not necessarily adjacent; i.e., have an edge between them. Social network metrics, such as geodesic (social distance) to a central character with certain attributes, are used to enhance the pattern detection. Thus, social network maps can be used to make visible patterns of referrals that are not currently easy to detect.

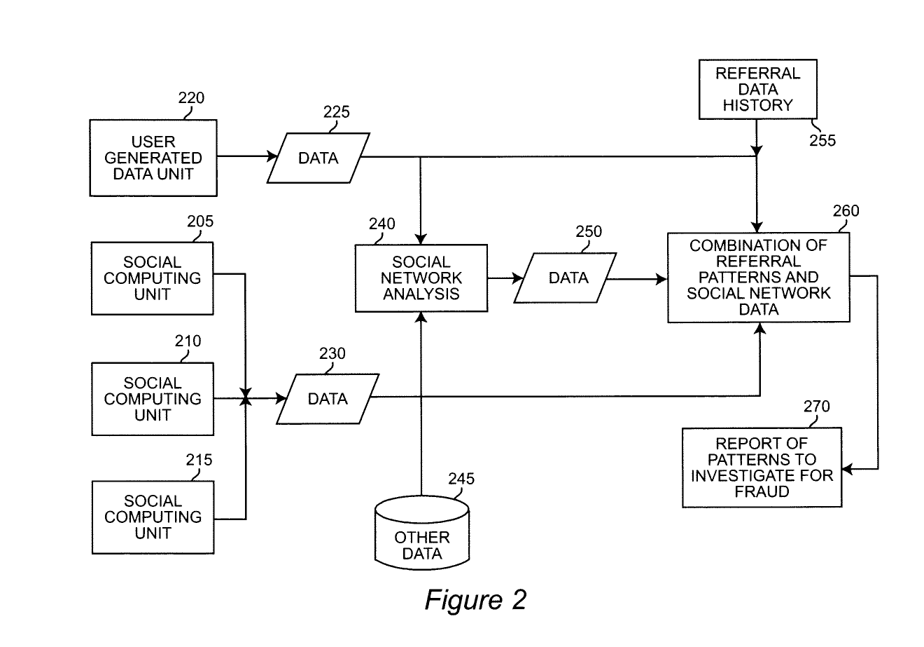

With reference to FIG. 2, an exemplary system according to the present invention can include a social network analysis (SNA) unit 240, which receives input from a plurality of disparate, heterogeneous data sources (e.g., 225, 230, 245). The present invention can provide automated collection (e.g., scrapping, parsing, etc.) combined with traditional user-generated (e.g., survey) methods for social network construction.

For example, with reference again to FIG. 2, data 230 can be derived (or automatically collected) from social computing units 205, 210, and 215). The social computing units 205, 210, and 215, can include, for example, email, instant messaging, blogs, wikis, auctions, web interactive communication or research, online social networking websites, etc.

On the other hand, data 225 can be derived from user generated data 220 (e.g., traditional surveys, a plurality of user generated data sources, etc.). In one aspect of the invention, the data sources include at least one user generated data source (e.g., a survey, etc.) and at least one non-user generated data source.

For example, according to the exemplary aspects of the present invention, a survey can be administered to a group of participants of an event prior to the event to obtain a plurality of user generated data. Another survey can be administered after the event, and/or after a predetermined period of time has elapsed from the time of the event.

Since some of the participants will have interacted at the event, and possibly gotten to know each other during the event, connections may have been made. As another example, some participants may have obtained ideas from participants who deal with patients, while others may derive patient diagnosis ideas from research specialists.

The present invention can perform social network analysis of the attendees based on survey information before the event, survey information after the event, and time delayed follow up survey information, which may include whether the participants are or have now talked or worked together. Also, secondary interactions/connections can be taken into account, such as participants connecting with others through other participants, or by word of mouth/e-mail, etc.

Those skilled in the arts of data processing would know and understand that other data 245 also can be derived or extracted from a variety of other sources, such as directories, etc.

The present invention can construct a social network from a plurality of disparate, heterogeneous data sources, such as survey data (e.g., a plurality of user generated data sources), social computing data, and combinations thereof. Hence, the present invention can provide attribute richness, including deterministic and probabilistic attributes, as well as capturing dynamic social network aspects (i.e., dynamic characterization of network components, that is, nodes and linkages) by extracting or obtaining data from disparate, heterogeneous data sources.

The aforementioned exemplary linkages between people can provide valuable metrics and can provide disparate, heterogeneous data to be used to compare the before and after states of the nodes and linkages of the social network and make business decisions.

Referring again to FIG. 2, the data 250 from the social network analysis unit 240 is input to unit 260 which also receives as inputs data 225, 230 and referral data history 255. Unit 26 analyzes the combination of referral patterns and social network data and generates as its output a report of patterns to investigate for fraud 270.

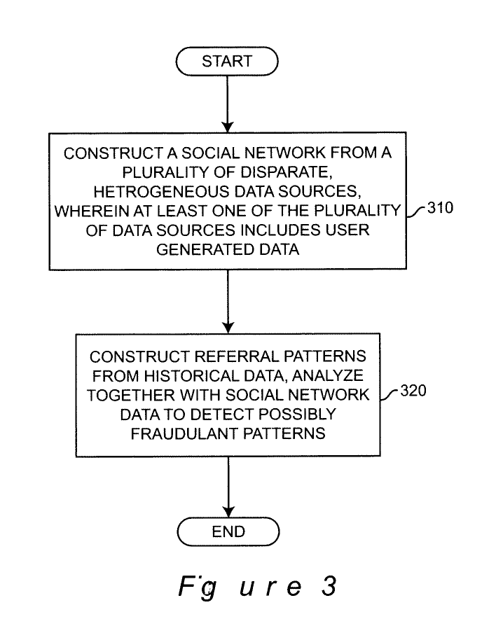

An exemplary method according to the present invention is described with reference to FIG. 3. With reference to the exemplary method illustrated in FIG. 3, a computer implemented method of constructing a social network includes, for example, constructing the social network from a plurality of disparate, heterogeneous data sources (e.g., see function block 310).

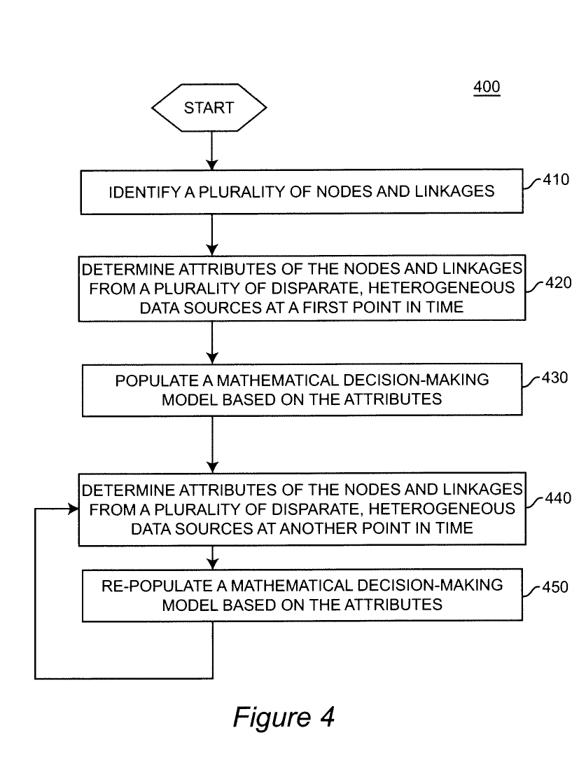

With reference to the exemplary method illustrated in FIG. 4, a computer implemented method of constructing the social network includes, for example, identifying a plurality of nodes and linkages in function block 410, and determining attributes of the nodes and linkages based on the plurality of disparate, heterogeneous data sources in function block 420. The attributes can include, for example, at least one of a deterministic attribute, a probabilistic attribute, and a dynamic attribute.

With reference again to FIG. 3, the present invention also can construct referral patterns from historical data, analyze the historical data together with social network data to detect possibly fraudulent patterns (e.g., see function block 320). In one aspect of the invention, the data sources include at least one user generated data source (e.g., a survey, etc.) and at least one non-user generated data source. Thus, social network optimization can be performed to make business decisions to use the information, for example, to identify places in social network that merit focus, to campaign in a certain way, etc.

With reference again to FIG. 4, the present invention exemplarily can populate a mathematical decision-making model based on the attributes in function block 430 (e.g., to perform social network analysis).

The present invention can determine attributes of the nodes and linkages from a plurality of disparate, heterogeneous data sources at another point in time (e.g., a second point in time after the first determination of attributes is made) in function block 440. The mathematical decision-making model can then be re-populated based on the second set of attributes in function block 450 (e.g., SNA can be re-performed). This process of determining attributes at different points in time and re-populating the decision-making model can be repeated, as exemplarily illustrated in FIG. 4 (e.g., SNA can be repeated).

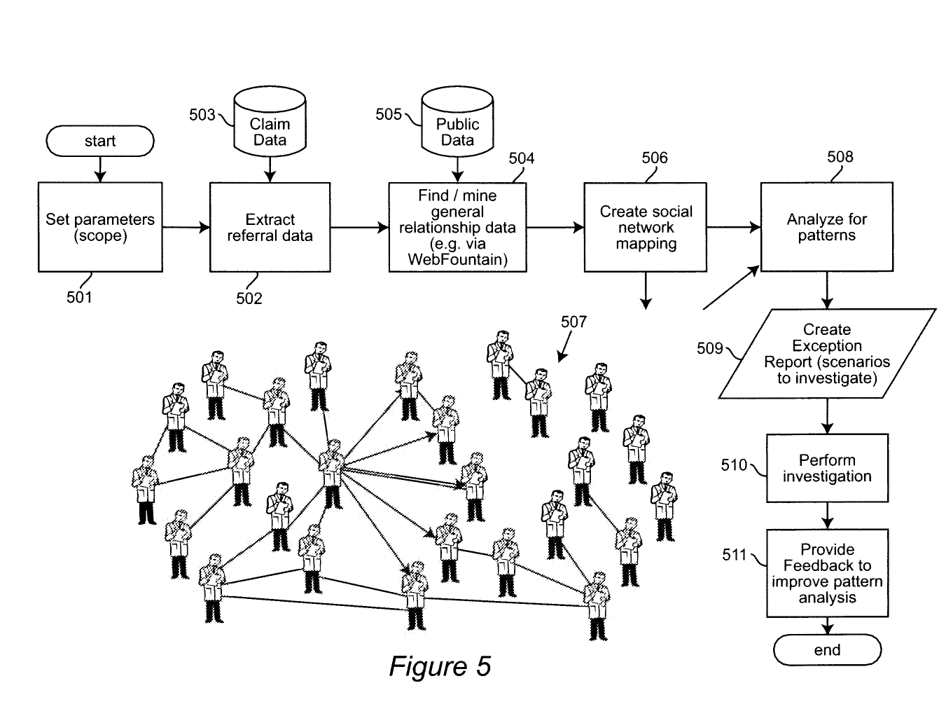

FIG. 5 illustrates how the invention is applied to health insurance fraud detection using social analytics. The process starts by setting parameters (i.e., the scope of the investigation) in function block 501. These parameters are used to extract referral data in function block 502 by accessing claim data in database 503. This referral data is then used in function block 504 to find, using data mining techniques, general relationship data between referring physicians and specialists. For example, International Business Machines (IBM) Corporation's DB2 database product incorporates data mining functions which can be used in the practice of the invention. This data is extracted from public data in database 505. The general relationship data is used in function block 506 to create a social network map 507, of the type described with reference to FIG. 1. This social network map is then analyzed in function block 508 to find patterns, again as described with reference to FIG. 1. On the basis of the analysis performed, an exception report is created and output in output block 509. This exception report lists scenarios that should be investigated. It is important to note that the analyzed patterns are used to steer insurance investigators toward claims that are more likely to be fraudulent. The analysis does not provide complete predictors of fraudulent activity; therefore, based on the exception report, investigations are performed at function block 510, and the results of those investigations are provided as feedback 511 to improve pattern analysis.

The invention not only produces the ability to help locate fraud itself, but it can be used with other fraud detection methods by adding to the positive confirmation score that might be used to tie the results of several methods together.

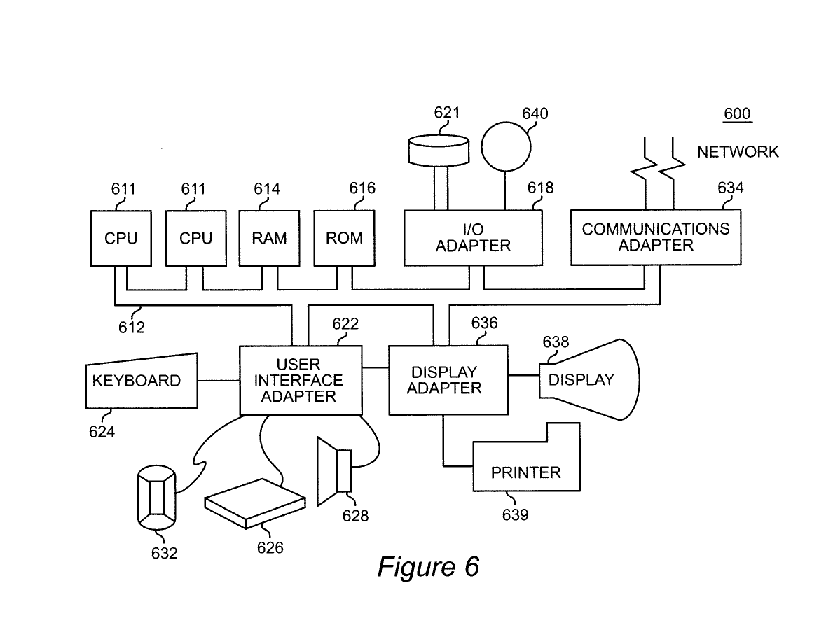

FIG. 6 illustrates a typical hardware configuration of an information handling/computer system for use with the invention and which preferably has at least one processor or central processing unit (CPU) 611. The CPUs 611 are interconnected via a system bus 612 to a random access memory (RAM) 614, read-only memory (ROM) 616, input/output (I/O) adapter 618 (for connecting peripheral devices such as disk units 621 and tape drives 640 to the bus 612), user interface adapter 622 (for connecting a keyboard 624, mouse 626, speaker 628, microphone 632, and/or other user interface device to the bus 612), a communication adapter 634 for connecting an information handling system to a data processing network, the Internet, an Intranet, a local area network (LAN), etc., and a display adapter 636 for connecting the bus 612 to a display device 638 and/or printer 639.

In addition to the hardware/software environment described above, a different aspect of the invention includes a computer-implemented method for performing the above method. As an example, this method may be implemented in the particular environment discussed above.

Such a method may be implemented, for example, by operating a computer, as embodied by a digital data processing apparatus, to execute a sequence of machine-readable instructions. These instructions may reside in various types of signal-bearing media.

This signal-bearing media may include, for example, a RAM contained within the CPU 611, as represented by the fast-access storage for example. Alternatively, the instructions may be contained in another signal-bearing media, such as a data storage disk/diskette, directly or indirectly accessible by the CPU 611.

Whether contained in the disk/diskette, the computer/CPU 611, or elsewhere, the instructions may be stored on a variety of machine-readable data storage media, such as direct access storage device (DASD) (e.g., a conventional “hard drive” or a RAID (redundant array of individual disk drives) array), magnetic tape, electronic read-only memory (e.g., ROM, EPROM, or EEPROM), an optical storage device (e.g. CD-ROM, WORM, DVD, digital optical tape, etc.), paper “punch” cards, or other suitable signal-bearing media including transmission media such as digital and analog and communication links and wireless. In an illustrative embodiment of the invention, the machine-readable instructions may comprise software object code, compiled from a language such as “C”, etc.

While the invention has been described in terms of a single preferred embodiment, those skilled in the art will recognize that the invention can be practiced with modification within the spirit and scope of the appended claims.

Having thus described our invention, what we claim as new and desire to secure by Letters Patent is as follows:

1. A computer implemented method for health insurance fraud detection comprising the steps of:
constructing a social network database of physicians and health care providers from multiple, disparate and heterogeneous data sources;
extracting data pertaining to referrals between physicians and health care providers from a claim database; and
analyzing extracted data pertaining to referrals using data from the social network database to detect patterns that help determine scenarios for investigation.

2. The computer implemented method for health insurance fraud detection recited in claim 1, wherein the step of constructing a social network of physicians and health care providers uses data mining techniques to find relationship data between physicians and health care providers.

3. The computer implemented method for health insurance fraud detection recited in claim 1, wherein the step of constructing a social network of physicians and health care providers identifies physicians and health care providers as nodes with linkages in a social network, wherein the linkages are deterministic and probabilistic attributes.

4. The computer implemented method for health insurance fraud detection recited in claim 3, further comprising the step of generating a graphical representation of the social network of physicians and health care providers.

5. A system for health insurance fraud detection comprising:
a plurality of disparate, heterogeneous data sources;
a social network analysis unit which receives input from said plurality of disparate, heterogeneous data sources and identifies relationship data between physicians and health care providers;
a social network optimization unit which receives input from said social network analysis unit and said plurality of disparate heterogeneous data sources and constructs a social network of physicians and health care providers;
data extracting means for extracting data pertaining to referrals between physicians and health care providers from a claim database; and
data analysis means for analyzing the extracted data pertaining to referrals using the social network to determine scenarios for investigation.

6. The system for health insurance fraud detection recited in claim 5 wherein said data sources include automated collection and user-generated data sources for social network construction.

7. The system for health insurance fraud detection recited in claim 5, wherein the constructed a social network of physicians and health care providers identifies physicians and health care providers as nodes with linkages in a social network, wherein the linkages are deterministic and probabilistic attributes.

8. The system for health insurance fraud detection recited in claim 7, further comprising means for generating a graphical representation of the social network of physicians and health care providers, which graphical representation also depicts referral patterns.

9. A computer readable medium having code which implements a method for health insurance fraud detection, the method comprising the steps of:
constructing a social network database of physicians and health care providers from multiple, disparate and heterogeneous data sources;
extracting data pertaining to referrals between physicians and health care providers from a claim database; and
analyzing extracted data pertaining to referrals using data from the social network database to detect patterns that help determine scenarios for investigation.

10. The computer readable medium having code which implements a method for health insurance fraud detection recited in claim 9, wherein the step of constructing a social network of physicians and health care providers uses data mining techniques to find relationship data between physicians and health care providers.

11. The computer readable medium having code which implements a method for health insurance fraud detection recited in claim 9, wherein the step of constructing a social network of physicians and health care providers identifies physicians and health care providers as nodes with linkages in a social network, wherein the linkages are deterministic and probabilistic attributes.

12. The computer readable medium having code which implements a method for health insurance fraud detection recited in claim 11, further comprising the step of generating a graphical representation of the social network of physicians and health care providers.
